(19) United States
(12) Patent Application Publication
(10) Pub. No.: US 2002/0061740 A1
(43) Pub. Date: May 23, 2002

(54) Method and devices for charging individual connection costs for a subscriber terminal connected to a private telecommunication network

(75) Inventors: Wolfgang Lautenschlager, Weissach-Flacht (DE); Hartmut Weik, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/985,259

(22) Filed: Nov. 2, 2001

(30) Foreign Application Priority Data
Nov. 18, 2000 (DE) 100 57 248.0

(51) Int. Cl. H04M 11/00

(52) U.S. Cl. 455/406; 455/414

(57) ABSTRACT

The present invention concerns a method for charging individual connection costs for a subscriber terminal (T111-T13; T211-T222) connected to a private telecommunication network (VPN1, VPN2, RPN), as well as a nodal point program module (KPM) for it, a network node (SW2, PB22) for it, a charge program module (GPM) for it and a charge facility (ACC1, ACC2, SCP) for it. According to the method, a private account is set up for the subscriber in a charge facility (SCP, ACCb2, ACC1) of the private telecommunication network (VPN1, VPN2, RPN). Both a connection request for the establishment of a connection and a debit code by which it is specified that the connection costs incurred for the connection are to be allocated to the private account (KT211, KT212, KT222) are sent to the private telecommunication network (VPN1, VPN2, RPN) from the terminal (T111-T13; T211-T222). The charge facility (SCP, ACC2, ACC1) allocates to the private account (KT211, KT212, KT222) the connection costs for the requested connection. For this, it is proposed that the connection requested by the subscriber is only established if, and/or only maintained for as long as the private account (KT211, KT212, KT222) is in credit.

### BACKGROUND OF THE INVENTION

The invention is based on a priority application DE 100 57 248.0, which is hereby incorporated by reference.

The present invention concerns a method for charging individual connection costs for a subscriber terminal connected to a private telecommunication network, as well as a nodal point program module for it, a network node for it, a charge program module for it and a charge facility for it.

In companies, authorities and other organisations, private telecommunication networks are installed via which both internal communication of the organisation and communication routed into the public telecommunication network is effected. A private telecommunication network is formed, for example, by means of one or more private branch exchanges and/or provided by a public telecommunication network, as a so-called virtual private network (VPN).

No costs are generally incurred for communication connections within a private telecommunication network, whereas substantial charges are payable in some cases for connections into the public network. For this reason, private communication from subscriber terminals connected to the private telecommunication network are restricted, for example, through so-called restriction numbers, so that defined communication partners can no longer be reached by the respective subscriber due to the restriction numbers. Other generally known solutions provide for private accounts to be set up for the connected subscribers in a private branch exchange. Connection costs incurred for private communication connections are then charged to the respective accounts. The amounts are accumulated and claimed from the respective account holder, e.g. monthly. Such a solution, however, is very problematic for reasons of data security, since the private communication behaviour of the respective subscriber can be easily traced. In addition, account settlement with the subscriber is expensive and, in the event of inability to pay on the part of the subscriber, subject to loss on the part of the operator of the private telecommunication network.

### SUMMARY OF THE INVENTION

The object of the present invention is the uncomplicated charging, under improved data security conditions, of individual connection costs for a subscriber terminal connected to a private telecommunication network.

Additionally provided for the purpose of achieving the object are: a nodal point program module according to the technical instruction of claim 13, a network node according to the technical instruction of claim 15, a charge program module according to the technical instruction of claim 16 and a charge facility according to the technical instruction of claim 17.

This invention is based on the concept that a private account, in the form of a credit account, is set up for the subscriber in a charge facility of the private telecommunication network, for example, in a private branch exchange or a charge computer. When the subscriber wishes to establish a private communication connection via the private telecommunication network, he sends to the private telecommunication network, from the terminal, a connection request for the establishment of the connection as well as a debit code which specifies that the connection costs incurred for the connection are to be allocated to the private account. The connection costs incurred for the requested connection are allocated to the private account by the charge facility. However, the connection requested by the subscriber is only established if, and/or only maintained for as long as the private account is in credit.

The subscriber can credit a sum of money to the private account at any time, e.g. by cheque or credit card payment, by electronic cash, by transfer or by any other form of payment. The respective depositor in this process, as well as the respective balance of the private account, expediently remain unknown to the operator of the private telecommunication network, so that optimum data security is ensured. In addition, the amount of money is already available to the operator in advance, so that he is not left with any debts not discharged by subscribers.

Further advantageous developments of the invention are disclosed in the dependent claims and in the description.

The private telecommunication network can comprise, for example, one or more private switching centres, each of which serves one or more terminals and which are connected to one another either directly, through so-called tie lines or other connections or indirectly, via a public telecommunication network. It is also expediently possible for the private telecommunication network to be configured as a virtual private network (VPN), which is preferably provided by a public telecommunication network, e.g. a conducted telephone network or mobile radio communication network, in the form of a so-called intelligent network. In principle, however, a VPN according to the invention can also be installed on a data network, for example, the Internet or other network, suitable for telecommunication, based on an Internet protocol, or on a mixed data and telephone network. In any case, subscriber terminals can be connected to a VPN directly or via private switching centres.

Connection requests by the subscriber to particular destinations, for example, to particular service numbers or to destinations abroad, are expediently rejected by the private telecommunication network on the basis of predefined restriction criteria. If the subscriber sends to the private telecommunication network a connection request which is to be charged to the private account, the private telecommunication network does not apply the restriction criteria to the connection request, or applies them only to a limited extent, so that, for example, the aforementioned service numbers are accessible to the subscriber.

It is also possible for the restriction criteria to prohibit in principle the establishment of the connection via at least one predefined transmission path so that, for example, a so-called carrier selection is not possible for the subscriber by which, for example, a predefined network operator is charged with the task of establishing the requested connection through dialling of a network operator prefix. Such a network operator prefix is blocked by the private telecommunication network due to the fact that, for example, the operator of the private network has concluded an exclusive contract with the network operator of a public telecommunication network for the establishment of communication connections. In any case, provision is made, in an advantageous variant of the invention, whereby the private telecommunication network permits the establishment of a connection for which the connection costs are allocated to the private account, including via transmission paths which are in principle blocked by restriction criteria, so that the connected subscribers can undertake the aforementioned carrier selection for private communication.

In a further advantageous variant, the private telecommunication network preferably establishes the connection on a transmission path predefined by the subscriber. For this purpose, for example, a network operator prefix is stored in a network node or in the charge facility of the private telecommunication network.

The preferred transmission path can also be stored in connection with a subscriber profile which is provided for the subscriber in the private telecommunication network. Such a subscriber profile also preferably includes other preferences of the subscriber, e.g. a personal abbreviated dialling directory and/or a personal telephone book and/or a least-cost routing table for the subscriber.

In an advantageous variant, the private account is also a constituent part of the subscriber profile of the subscriber.

In principle, several variants are possible for account status information in respect of the private account. For example, the subscriber can query the account status from the charge facility. Preferably, however, the charge facility sends a message to the terminal concerning the particular status of the private account. The terminal can then visually and/or acoustically indicate the status to the subscriber, so that if necessary the subscriber can terminate a connection on his own initiative before his credit on his account is used up.

Various measures, which can be realized either singly or in any combinations, are possible as protection against improper use of a private account:

The subscriber can send a personal user code, assigned to him as a debit code for his private account, to the private telecommunication network. For example, this can be an alphanumeric code which is sent to the private telecommunication network by, for example, DTMF (dual tone multi-frequency) signalling or by means of an ISDN UUS message (ISDN=integrated services digital network/UUS=user-to-user signalling).

As a further protective measure, a password can be sent to the private telecommunication network, e.g. by means of the above notification methods.

It is also possible for the charge facility to request the subscriber, in a credit and/or debit operation, to give an identification code and/or an authentication code or for the subscriber to give such codes, without being requested, in the case of the above-mentioned transactions.

A subscriber can also use the tariff advantages of the private telecommunication network for private communication connections. Particularly favourable, individually applicable charge tariffs solely for connections of the particular private telecommunication network are frequently agreed for this. When a subscriber requests a private connection, via the private telecommunication network and/or via a public communication network, which is to be charged to his private account, the connection costs incurred for this connection are expediently determined according to the individually applicable charge tariff for the telecommunication network and charged to the private account.

A further possibility relating to the cost-optimized establishment of connections for the respective subscriber is expediently created in that the connection is preferably established on transmission paths of the private telecommunication network, in particular, on transmission paths between switching centres of the private telecommunication network. This variant takes account of the fact that private telecommunication networks are frequently formed by distributed private switching centres which are networked to one another and/or by virtual private networks (VPN). These private switching centres are also frequently disposed in different public local networks. Provided between the private switching centres in some cases are transmission paths which are established on fixed lines or leased lines and therefore render possible connections at particularly favourable charge tariffs. In any case, transmission paths between switching centres or other telecommunication facilities of the private telecommunication network are generally more favourable, in respect of incurred charges, than connections via public telecommunication networks, these favourable transmission paths being used as much as possible in the above-mentioned advantageous variant. In this case, a connection which is to be charged to a private account of a subscriber connected to a first private switching centre is then established on, for example, a transmission path existing between the first and a second private switching centre located in another public local network. No charges or, in any case, favourable charges, are incurred for this transmission path. On the public telecommunication network side, only favourable charges are incurred for a connection section established in the local network of the second private switching centre.

In principle, charges can also be debited from a private account for connections or connection sections established on a private telecommunication network. However, it is also possible for these connections or connection sections to be free of charge and for the private account to be debited only with charges incurred for connection sections established outside the private telecommunication network.

### BRIEF DESCRIPTION OF THE DRAWINGS

The invention and its advantages are explained below with reference to an embodiment example, with the aid of the drawing.

FIG. 1 shows an arrangement for the realization of the method according to the invention, with switching centres SW1, SW2, PB22 designed as network nodes according to the invention, charge facilities ACC1, ACC2 according to the invention, as well as charge program modules GPM and nodal point program modules KPM.

FIG. 2 shows a nodal point program module KPM in schematic form.

FIG. 3 shows a charge program module GPM in schematic form.

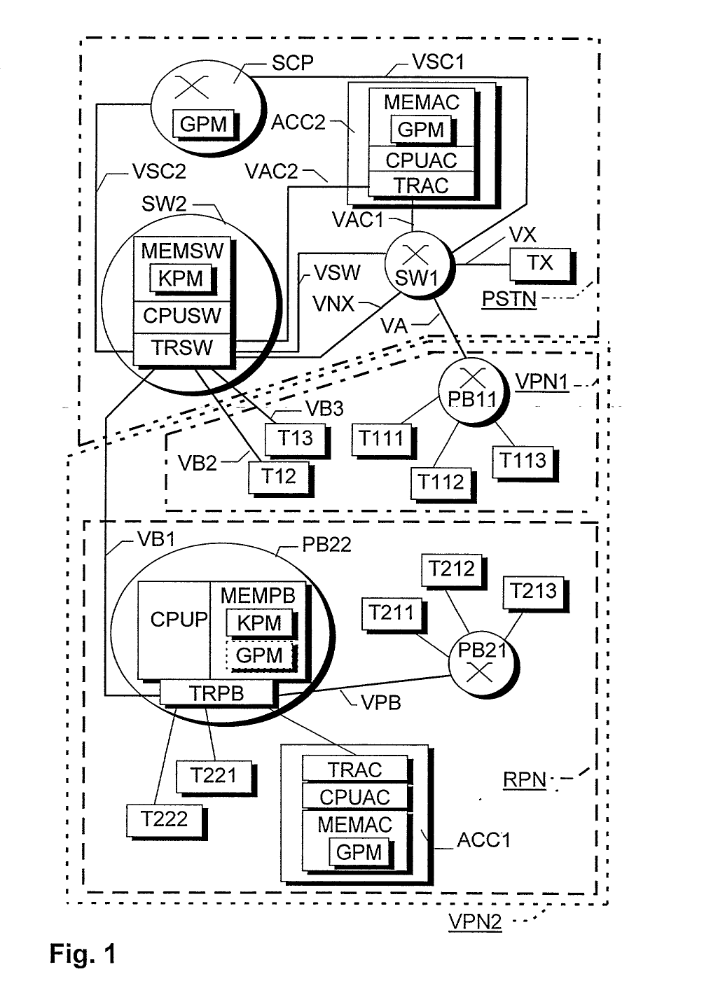

Depicted in FIG. 1 is an illustrative arrangement with which the invention can be realized. FIG. 1 shows a public telecommunication network PSTN, as well as private telecommunication networks VPN1, VPN2 and RPN.

The public telecommunication network PSTN can be, for example, an ISDN (integrated services digital network) telecommunication network, a mobile radio telecommunication network, e.g. a GSM network (GSM=global system for mobile communication), or a data network, as well as any combination of such networks. In this case, the telecommunication network PSTN is designed as a so-called intelligent network. Of the telecommunication network PSTN, only switching centres SW1, SW2, a service control node SCP and a charge server ACC2 are shown, being representative of switching centres, network management systems, connection lines, etc., which are not depicted. In this case, the switching centres SW1, SW2 are so-called service switching points (SSP) and the service control node SCP is a so-called service control point (SCP) of an intelligent network. The basic functions of a service switching point and of a service control point are standardized by the ITU (International Telecommunication Union) and therefore do not need to be explained further at this point.

The switching centres SW1, SW2 are embodiment examples for network nodes according to the invention, the service control node SCP and the charge server ACC2 being embodiment examples of charge facilities according to the invention. In this case, the charge server ACC2 records for the virtual private network VPN2 connection costs of connections routed out from the VPN2 into the public telecommunication network PSTN. In principle, the charge server ACC2 could also record connection costs of connections established within the virtual private network VPN2. In a manner similar to the charge server ACC2, the service control node SCP, performing the functions of charge facility according to the invention, records connection charges of connections routed out from the virtual private network VPN1 into the public telecommunication network PSTN.

The switching centres SW1, SW2 communicate with one another via connections VSW, VNX, and each communicates with the service control node SCP via a connection VSC1, VSC2 and with the charge server ACC2 via a connection VAC1, VAC2 respectively. The connections VSW, VNX, VSC1, VAC1; VAC2 are routed via facilities of the telecommunication network PSTN which are not depicted. The connection VSW represents, for example, one or more connections with channels for useful data and channels for signalling data, and is operated by the operator of the telecommunication network PSTN. The connection VNX, on the other hand, is an alternative transmission path to the connection VSW and is operated by a further operator, not represented. The connections VSC1, VSC2, VACL1; VAC2 are connections which are preferably routed via a LAN (local area network) and/or via a signalling channel and/or via a signalling network. Such a signalling network is, for example, the central signalling system No. 7. On the connections VSC1, VSC2, VAC1; VAC2, communication is preferably effected by means of the INAP protocol (INAP=intelligent network application part).

A terminal TX of a subscriber SX, not represented, which is, for example, a conducted telephone and is connected to the switching centre SW1 via a subscriber connection line VX, is shown by way of example for any other terminals connected to the telecommunication network PSTN.

The private telecommunication networks VPN1, VPN2 are virtual private telecommunication networks (VPN) which are established with the aid of the public telecommunication network PSTN, whereas the private telecommunication network RPN is a real private telecommunication network formed by private switching centres PB21, PB22 and terminals T211, T212, T213 and T221, T222 connected respectively to them. The terminals T211, T212, T213 and T221, T222 are, for example, conducted telephone sets, DECT terminals (DECT=digital enhanced cordless telecommunications) or personal computers, and assigned to subscribers S211, S212, S213, S221, S222, not represented. The switching centres PB21, PB22 are connected to one another via a line bundle VPB, a so-called tie line, or other connection line, which contains one or more signalling and useful-data channels.

The telecommunication network RPN can also be referred to as a local private branch telecommunication network or, in short, as a private branch network, and is installed, for example, within a building complex of a company or other organisation. The switching centres PB21, PB22 are so-called private automatic branch exchanges (PABX) or private branch exchanges (PBX). The telecommunication network RPN is connected to the public network PSTN via connection line VB1 which is routed from the switching centre SW1 to the switching centre PB22. The connection line VB1 is, for example, an ISDN subscriber connection line with several useful-data channels and one or more signalling channels.

The telecommunication network RPN comprises a charge server ACC1, designed as a charge facility according to the invention, for charging individual connection costs of the connected terminals T211, T212, T213; T221, T222 of subscribers S211, S212, S213, S221, S222, not represented. In this case, the charge server ACC1 records connection costs of connections which are established via the public telecommunication network PSTN and are routed out of the telecommunication network RPN, for example, connections to the terminal TX. The switching centre PB22 establishes these connections out of the telecommunication network RPN into the public telecommunication network PSTN. In principle, the charge server ACC1 could also record connection costs of connections established within the private telecommunication network RPN.

The virtual private telecommunication network VPN1 is established on the public telecommunication network PSTN and comprises terminals T12, T13 connected to the switching centre SW2 as well as a private switching centre PB11, connected to the switching centre SW1, and terminals T111, T112, T113 connected to it. The terminals T12, T13; T111, T112, T113, which are assigned to subscribers S12, S13; S111, S112, S113, not represented, are for example conducted telephone sets, DECT terminals or personal computers. The switching centre PB11 can be designed as a conducted switching centre and/or as a radio communication base station, e.g. a DECT base station. The switching centre PB11 can be installed, for example, in a company building, whereas the terminals T12, T13 belong to field service employees or home-workers, who dial into the virtual private network VPN1 from outside.

An important service of the virtual private network VPN1 in this case is the provision of a so-called call number plan, in which there is assigned to each of the subscribers connected to the network an internal VPN call number which can be independent of a call number which is valid for each subscriber in the public telecommunication network PSTN. For example, the terminals T12, T13; T111, T112, T113 can be mutually accessible under internal VPN logical call numbers 1912, 113; 1111, 1112, 1113, whereas from outside, from the terminal TX for example, in each case it is necessary to dial public call numbers 04711-12, 04711-13; 04711-111, 04711-1912 and 04711-113 respectively. The necessary conversion of an internal VPN call number into public call numbers and vice versa is performed interactively, in a known manner, by the switching centres SW1, SW2, designed as service switching points, and the service control node SCP, designed as a service control point.

In this case, although the terminals T12, T13 are connected to the switching centre SW2, the subscribers S12, S13 could nevertheless also connect, for example, either to the switching centre PB1 or to the switching centre SWI, or to another switching centre, not represented, of the public telecommunication network PSTN. The respective assignment of physical address, e.g. call number of a subscriber connection line, to logical, internal VPN call number is then recorded in the service control node SCP and/or in the switching centre PB1. Procedures for dialling into a VPN, possibly with the giving of a password, are known in the art and are therefore not explained further.

The virtual private network VPN2 comprises the facilities of the telecommunication network RPN and the components of the virtual private network VPN1, i.e., the switching centre PB1 and the terminals T12, T13; T111, T112, T113, and is established on the public telecommunication network PSTN. A private call number plan is likewise applicable to the private network VPN2, the internal call numbers 212, 213; 2111, 2112, 2113 being assigned to the terminals T12, T13; T111, T112, T113 and the internal call numbers 2212, 2213, 2221, 2222 being assigned to the terminals T211, T212, T213, T221 T222, T211. From outside, i.e., for example, from the subscriber terminal TX of the telecommunication network PSTN, the said internal VPN call numbers must be preceded by a prefix, e.g. a digit sequence “048”.

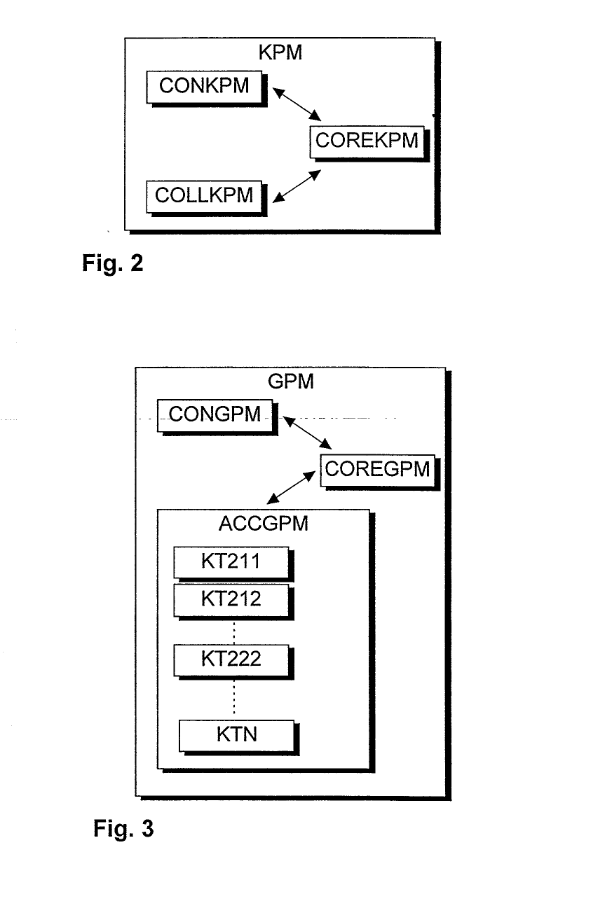

Of the switching centre SW2, some principal components are shown by way of example, namely, a connection means TRSW, as well as a control means CPUSW and a storage means MEMSW. By means of the connection means TRSW, firstly, the switching centre SW2 can establish data and speech connections to subscribers or to other switching centres, e.g. the connections VB1 and VSW. Secondly, the connection means TRSW can also establish signalling connections such as, for example, the connection VSC2 to the service control node SCP. The control means CPUSW is a processor or a group of processors which execute program code of program modules, for example, of the nodal point program module KPM shown schematically in FIG. 2, which are stored in the storage means MEMSW. Under control of an operating system, the control means CPUSW controls the functions of the switching centre SW2 by means of the program modules and thereby influences, for example, the functions of the connection means TRSW, serving as transmitting and receiving means. The connection means TRSW, the control means CPUSW and the storage means MEMSW are connected to one another by connections which are not shown in FIG. 1. In addition, the switching centre SW2 can comprise further units, e.g. a coupling network or an interface to a network management system.

In this case, the switching centre SW1 is of the same type of construction as the switching centre SW2 and, like the latter, performs the functions according to the invention which are to be described at a later point. However, the switching centre SW1 could also be a conventional, known switching centre.

The private switching centre PB22 is essentially of the same type of construction as the switching centre SW2. For this reason, its components are not explained in detail. In this case, a control means CPUP corresponds to the control means CPUSW, storage means MEMPB correspond to the storage means MEMSW and connection means TRPB, serving as transmitting and receiving means, correspond to the connection means TRSW. Under control of an operating system, the control means CPUPB controls the functions of the switching centre PB22 by means of program modules, for example, the modules nodal point program module KPM and charge program module GPM, represented schematically in FIGS. 2 and 3 respectively, and thereby influences, for example, the function of the connection means TRPB.

The service control node SCP comprises connection means, not represented, for establishing data and/or signalling connections, as well as control means, e.g. processors, and memory means, e.g. RAM modules and hard disk drives, serving as working memories, and is controlled by program modules under control of an operating system. In this case, the control means of the service control node SCP execute the charge program module GPM, shown schematically in FIG. 3, which is stored in the storage means of the service control node SCP.

The charge servers ACC1, ACC2 are charge facilities according to the invention and, in this case, are of the same type of construction. The charge servers ACC1, ACC2 have connection means TRAC for connection to the switching centres PB22; SW1, SW2 and comprise control means CPUAC and storage means MEMAC. The storage servers ACC1, ACC2 can be computers which are operated by, for example, a UNIX operating system or a Windows NT operating system. The control means CPUAC is a processor or a cluster of processors which executes the commands of the operating system which is stored in the storage means MEMAC. Program code sequences of program modules which are executed by the control means CPUAC can also be stored in the storage means MEMAC which comprises, for example, a hard disk or RAM modules. Such a program module is, for example, the charge program module GPM shown in FIG. 3. The control means CPUAC also influence the functions of the connection means TRAC, by means of which, for example, the connections VAC1, VAC2 can be established. The connection means TRAC are, for example, plug-in network cards, modems and the like, which may comprise their own programs which control them and are executed by them themselves and/or by the control means CPUAC. In this case, the functions, according to the invention, of the charge servers ACC1, ACC2 are preferably rendered through execution of the charge program modules GPM in cooperation with the described hardware. The charge servers ACC1, ACC2 also comprise further units, not represented in FIG. 1, e.g. monitors, keyboards and computer mice. The charge servers ACC1, ACC2 can also serve other public and/or private switching centres, not represented, in addition to the switching centres PB22; SW1, SW2.

The nodal point program module KPM and the network facility program module NPM are generated in, for example, a programming language, for example, “C”, “C++”, Java or the like, and are then translated by a compiler or an interpreter into program code which can be executed by the control means CPUSW, CPUPB, CPUAC. In respect of function, the modules KPM, GPM are represented in schematic form only and can also be configured differently in each individual case. The modules KPM, GPM each comprise a central control unit, which is denoted by COREKPM, COREGPM and which calls up functions and subroutines which are described in greater detail below.

The central control units COREKPM, COREGPM control the connection functions CONKPM and CONGPM, which each serve respectively as connection means. In addition, the object program module ZPM comprises a charge recording function COLLKMP, serving as a charge recording means, and the charge program module GPM comprises an account management function ACCGPM, serving as an account management means.

The respective aforementioned functions are to be explained using, as examples, the nodal point program module KPM installed in the switching centre PB22 and the charge program module GPM installed in the charger server ACC1.

In this case, the terminal T222 represents a subscriber of the private telecommunication network RPN.

The connection function CONKPM serves to receive a connection request from a terminal for the establishment of a connection, for example, a connection request which is sent from the terminal T222 to the switching centre PB222 for the establishment of a connection to the terminal TX. The connection function CONKPM further serves to receive a debit code which specifies that the connection costs incurred for the connection are to be allocated to a private account of the subscriber. For example, business connections requested by the subscriber S222 are not charged to his private account.

In the present example, the subscriber S222 gives a debit code, for example, in the form of a prefix to a numerical code which the terminal T222 sends to the switching centre PB22 and which specifies that the connection costs incurred for the connection are to be allocated to a private account KT222 of the subscriber S222. In this case, this account KT222 is managed by the account management function ACCGPM of the charge program module GPM installed in the charge server ACC1.

The connection function CONKPM can additionally establish a requested connection, for example, it can instruct a coupling network, not represented, of the switching centre PB22 to switch a connection between the terminal T222 and the subscriber connection line VB1, and send a call signalling message to the switching centre SW2 for the establishment of the connection to the terminal TX. The charge recording function COLLKPM records the connection costs incurred for the requested connection and allocates them to the private account KT222 of the subscriber S222. For this purpose, the charge recording function COLLKPM sends, for example, charge pulses or charge messages, termed charge tickets, to the account management function ACCGPM of the charge program module GPM. In the present example, the latter is executed by the charger server ACC1. In a variant of the invention, however, the charge program module GPM could also be executed by the switching centre PB22 and is therefore indicated by a broken line in its storage means MEMPB.

The charge recording function COLLKPM and the connection function CONKPM operate together in such a way that the connection requested by the subscriber S222 is only established if, and/or only maintained for as long as the private account KT222 is in credit.

Even before the establishment of the connection between the terminals T222, TX, therefore, the connection function CONKPM or the charge recording function COLLKPM sends a query to the account management function ACCGPM concerning whether the private account KT222 is in credit. Only if such is the case is the connection established between the terminals T222, TX. Furthermore, the charge recording function COLLKPM and/or the connection function CONKPM could send a query to the telecommunication network PSTN concerning which charge tariff is payable for the requested connection and, in the event of there being insufficient credit in the private account KT222, reject the establishment of the connection between the terminals T222, TX. Moreover, the nodal point program module KPM and/or the device respectively executing the latter, for example, the switching centres PB, SW2, could comprise a charge table specifying which charge tariff is to be applied to the requested connection.

The charge recording function COLLKPM also checks following any establishment of the connection between the terminals T222, TX whether the private account KT222 is in credit. For this, the charge recording function COLLKPM queries the respective credit, for example cyclically, from the charge program module GPM. Furthermore, the account management function ACCGPM could acknowledge charge tickets sent by the nodal point program module KPM with messages providing information on the respective remaining credit or, in the case of exhausted credit, send a corresponding message concerning the lack of credit to the nodal point program module KPM.

The continuous checking of the credit can also be omitted, for example, if connection costs are incurred solely for the establishment of a connection and only these have to be debited from the respective account.

The connection function COMGPM of the charge program module GPM is designed for communication with the nodal point program module KPM and, for this purpose, controls the connection means TRAC in the charge server ACC1. In this case, the connection function CONGPM receives, for example, the above-mentioned charge tickets and sends acknowledgement messages for them, as well as response messages to queries concerning a credit in an account.

The account management function ACCGPM is responsible for the management of private subscriber accounts. Some of these accounts are shown by way of example for the charge program module GPM installed in the charge server ACC1 or in the switching centre PB22: accounts KT211, KT212, KT222 are set up for the subscribers S211, S212, S222. An account KTN represents, by way of example, n further subscriber accounts, which are not shown. The quantity and designation of the respective accounts can be set through configuration data in the charge program module GPM. Accordingly, the charge program module GPM which is installed in the charge server ACC2 and is responsible for the charging of the virtual private network VPN2 comprises the same accounts as the charge program module GPM installed in the charge server ACC1 and, in addition, accounts for the subscribers T12, T13; T111, T112, T113, whereas the charge program module GPM installed in the service control node SCP only manages accounts of the last-mentioned subscribers.

The respective accounts of the charge program modules GPM can be credited individually. For this purpose, an amount is remitted to the respective account by, for example, electronic cash, by transfer, by cheque card, by credit card or by other form of payment and recorded by the account management function ACCGPM. Such recording procedures, which are protected if necessary by passwords, single-use transaction codes and the like, are known in the art and do not require further explanation. Furthermore, several accounts belonging to one subscriber can each be credited individually. For example, the subscriber T221 can enter a first amount in his account KT221 managed by the charge server ACC1 in respect of the telecommunication network RPN and a second amount in his account managed by the charge server ACC2 in respect of the virtual private network VPN2. Moreover, several private accounts can be set up for one subscriber in the charge program module GPM or other charge facility according to the invention.

In addition, the account management function ACCGPM responds to queries which are preferably sent by a nodal point program module KPM or a network node according to the invention and in which the respective credit of an account is queried prior to the establishment of a connection which is liable to costs, so that this connection can only be established if the private account is in credit. It is also possible for a query concerning the credit of a private account, e.g. the account KT222, to be sent from a terminal, for example, from the active terminal T222 in the above example, to the charge program module GPM installed in the charge server ACC1 and answered by the latter. It is understood that, in the case of such a query, the person making the query must in each case appropriately identify and/or authenticate himself by means of passwords, access codes, image and/or voice recognition.

The account management function ACCGPM is designed both for entering a credit and for debiting connection costs which are incurred for a connection requested from a terminal, e.g. the terminal T222, together with a debit code for the private account, e.g. the account KT222, and established by the private telecommunication network PSTN, namely, in this case, the connection between the terminals T222 and TX. As mentioned, for this purpose the nodal point program module KPM sends corresponding charge tickets to the charge program module GPM, which debits the amounts specified therein from the account KT222. The account management function ACCGPM operates together with the switching centre PB222, designed as a network node according to the invention, in such a way that a connection requested by a subscriber, in this case, by the subscriber S222, is maintained only as long as the private account KT222 is in credit. As soon as the latter is used up, the account management function ACCGPM sends a corresponding message to the switching centre PB22. In this case, however, the charge program module GPM acknowledges the charge tickets signalled by the switching centre PB22 with messages concerning the respectively current credit status of the account KT222, so that the nodal point program module KPM is constantly informed concerning the current credit.

The charge program module GPM of the charge server ACC1 also expediently sends to the terminal T222 messages concerning the respective status of the private account KT222, so that the terminal T222 can indicate the status to the subscriber S222 visually, e.g. on a display, and/or acoustically, e.g. by means of an output on a handset or a loudspeaker.

The switching centre PB22 and the charge server ACC1 also serve as a network node or charge facility according to the invention for the further terminals T221, T211, T212, T213 of the telecommunication network RPN, in addition to the terminal T222.

The respective functions CONKPM, COLLKPM; CONKPM, ACCGPM of the modules KPM, GPM can be designed solely for communication with the central control units COREKPM, COREGPM respectively assigned to them, as well as for direct communication and/or direct mutual function callup in each case, in which case the central control units COREKPM, COREGPM may not be absolutely essential.

The charge program module GPM and the nodal point program module KPM can be realized in a common program module which performs the functions of both modules.

In the case of the embodiment according to the invention, several variants are possible, some of which are explained below:

For example, the terminal T211 sends a connection request, for a connection to the terminal TX, to the switching centre PB21. The latter forwards the connection request to the switching centre PB22. The switching centre PB22 recognizes, on the basis of a call number RNX of the terminal TX specified in the connection request (not represented in FIG. 1), that the requested connection is a private connection. The call number RNX is entered in a list of restriction criteria by which connection requests by subscribers S211, S212, S213, S221, S222 of the telecommunication network RPN to predefined destinations, for example, to international destinations or particular service numbers, are rejected. The switching centre PB22 consequently sends a message to the terminal T211 that the requested connection can only be established if the subscriber S211 wishes to charge the connection costs incurred in this instance to his private account KT211. In this example, the subscriber S211 gives the required debit code, e.g. as a DTMF code, on the terminal T211. In addition, the subscriber gives a password which is checked in conjunction with the debit code by the charge program module GPM.

Following receipt of the debit code, and if there is sufficient credit in the account KT211, the switching centre PB22 no longer applies the restriction criteria, i.e., the connection to the terminal TX is established. It is also possible for the restriction criteria to continue to be applied to a limited extent even in the case of debiting of a private account. For example, it can be undesirable on the part of an employer for certain call numbers to be inaccessible during working hours.

Furthermore, the restriction criteria can prohibit the establishment of a connection via a predefined transmission path. In the present case, for example, it is determined for the telecommunication network RPN that connections normally established by the latter into the telecommunication network PSTN, e.g. business connections, are routed only via transmission paths of the telecommunication network PSTN. If, for example, the terminal TX is accessed from the telecommunication network RPN, the connection VSW is selected for this. Due to a charge tariff which is individually applicable to the private telecommunication network RPN, the connection costs incurred in this case may possibly be less than in the case of a connection on the alternative transmission path VNX so that, in the above example, the subscribers T222 and T211 benefit, in their respective private connections to the terminal TX, from the lower connection costs agreed for the telecommunication network RPN.

It is also possible, however, for the connection costs to be higher on the transmission path VSW which the telecommunication network RPN has to use, as it were, compulsorily, than on the transmission path VNX operated by another operator. This compulsion, which is determined by, for example, a contract between the operators of the telecommunication networks RPN and PSTN, need not apply to private connection. If, for example, a connection is to be established from the terminal T222 to the terminal TX for which the incurred connection costs are to be allocated to the account KT222, it can be determined from the terminal T222, e.g. through the prefixing of an access code, that the requested connection is to be established on the transmission path VNX, in which case the telecommunication network RPN does not apply the restriction criteria, due to the debiting of the private account.

It is also possible to predefine for the terminal T222, e.g. through a subscriber profile stored in the switching station PB22, that the transmission path VNX is always to be selected for connections to be charged to the private account KT222. Furthermore, it is possible to define for the terminal T222 not only one transmission path, but several transmission paths, to be selected time-dependently in each case, which are entered in, for example, a so-called least-cost routing table.

Explained in the following example is the establishment of a connection from the terminal T12, the terminal in the example representing a terminal of the virtual private network VPN1.

The terminal T12 is not continuously connected to the virtual private network VPN1, but logs-on to the latter on a case by case basis. For example, after being previously, as it were, “off-net”, the terminal T12 is connected to a subscriber-side connection box, not represented, of the subscriber connection line VB2. The terminal T12 then sends to the switching centre SW2, as part of a known log-on procedure, an access code for the purpose of logging on to the virtual private network VPN1. The access code can be, for example, a call number which contains a VPN service code—a VPN group number identifying the individual VPN1—and the call number of the terminal T12 within the call number plan of the private network “1912”. Due to its capacity as an SSP, the switching centre SW2 identifies the corresponding VPN log-on messages and fetches the necessary instructions from the service control node SCP for the purpose of processing them. Additionally stored in the service control node SCP is the fact that the terminal T12 is now connected to the subscriber connection VB2 and can be accessed via the switching centre SW2, under the internal VPN call number “1912”. In principle, the terminal T12 can log-on to the network VPN1 for one connection request in each case (“call-by-call”) or, for a longer period, for several incoming and/or outgoing connections. Furthermore, it is possible in principle for the subscriber connection line VB2 to be treated by the telecommunication network PSTN as a subscriber connection line assigned to the private network VPN1. The terminal T12 would not then have to log-on as a subscriber of the private network VPN1 but, for a connection out from the network VPN1, e.g. to the terminal TX, as it were log-off by giving a so-called escape code, e.g. by prefixing a “0” to a connection request.

When the subscriber S12 requests from the switching centre SW2 connections within the virtual private network VPN1, e.g. to the terminal T113, he gives only its internal VPN call number 1113. The switching centre SW2 then establishes the requested connection VB2, VSW, VA, P11 through interaction with the service control node SCP in which, for example, the call-number which is assigned to the terminal T113 and, as it were, “physically” valid in the telecommunication network PSTN is ascertained.

Also stored in the service control node SCP, in addition to a VPN call number to PSTN call number assignment entry, is a subscriber profile for the subscriber S12 which contains a personal abbreviated dialling directory, a personal telephone book and a least-cost routing table. The subscriber profile can be configured by, for example, a network management system, not represented, and/or by the subscriber S12 himself, e.g. via an Internet interface of the service control node SCP which can be used by means of a browser (e.g. a Netscape Navigator). A private account KT12 assigned to the subscriber is managed by the charge program module GPM installed in the service control node SCP. The private account KT12 can also be part of the above-mentioned subscriber profile or other subscriber-specific data of the subscriber S12 stored in the service control node SCP. Furthermore, in this case, restriction criteria concerning conditions permitted for the subscriber S12 are also stored in the service control node SCP. Thus, for example, a connection to the subscriber T211 via the virtual private network VPN1 is not permitted. If the subscriber S12 wishes to establish such a connection, he must send a debit code to the switching centre SW2 that his private account KT12 is to be debited with the connection costs incurred in that case. The switching centre SW2 and the service control node SCP operate together in the debiting of the private account KT12 as already described, for example, for the switching centre PB22 and the charge server ACC1.

In principle, several variants are then possible:

For example, the debiting of the private account KT12 can be an integrated IN service (IN=intelligent network), in which the processing of the connection request message for Connection to the terminal T211 and the debiting of the private account KT12 are executed interactively in a service procedure by the switching centre SW2 and the service control node SCP.

It is also possible for the switching centre SW2 and the service control node SCP to first execute the processing of the connection request as a VPN-IN service. This IN service then becomes, as it were, a background process, and the switching centre SW2 and the service control node SCP, in a process according to the invention, interactively execute the debiting of the private account KT12 with the charges incurred for the connection.

When the subscriber S12 logs-on to the switching centre SW2 with his terminal T12 as a subscriber of the virtual private network VPN2, although the service control node SCP also makes available the subscriber profile of the subscriber S12 which is valid for the network VPN2 and, operating together with the switching centres SW1, SW2, processes the respective VPN-specific functions, the charge server ACC2 is responsible for any necessary charging of connection costs incurred for private connections.

In a further situation, a connection is to be established from the terminal T213 which, in the example, represents a member of the virtual private network VPN2, to the terminal TX, the connection costs to be charged co a private account KT213 of the subscriber S213, which is not represented, and which is managed by the charge server ACC2. Although this connection could be established to a large extent via the public telecommunication network PSTN, it would then be relatively expensive. The connection is therefore preferably established on transmission paths of the private telecommunication network VPN2 which, although routed in this case via the telecommunication network PSTN, are nevertheless cost-effective for the subscriber S213 because they are VPN connections. In this case, the connection is first established, for example, on the transmission paths VB1, VSW, VA to the switching centre P11 belonging to the network VPN2. The switching centre P11 then completes the requested connection to the terminal TX on the lines VA, VX via the switching centre SW1. Expediently in this case, only the connection costs incurred for the connection on the lines VA, VX are charged to the private account KT213. It is also possible, however, that charges incurred on transmission paths VB1, VSW, VA are additionally charged to the private account KT213.

Further variants of the invention are easily feasible:

The switching centres SW1 and/or SW2 serving as service switching points (SSP) could each be combined with the service control node SCP to form a combined facility, a so-called service switching and control point (SSCP).

It is also possible for the switching centre SW1 to be a conventional switching centre and for only the switching centre SW2 to be an SSP, or vice versa. IN service requests received by the switching centre SW1 are then forwarded by the latter to the switching centre SW2, where they are then processed in combined operation with the service control node SCP.

The network nodes according to the invention, e.g. the switching centres SW1, SW2, PB22, could also be, for example, so-called VoIP gateways (VOIP=voice over Internet protocol) which render possible speech transmission and/or image transmission via the Internet or via another data network. Such gateways can additionally be designed as charge facilities according to the invention, e.g. through installation of charge program modules GPM.

The subscriber connection lines VA, VB1, VB2 and VB3 could also be designed as DSL (digital subscriber line) or powerline subscriber connection lines (=telecommunication connections via the electrical power network). Furthermore, they could be WLL connections (WLL wireless local loop).

The telecommunication network RPN can also comprise further components, e.g. further terminals which are connected to the switching centres PB21, PB22 or further switching centres, not represented. Furthermore, the telecommunication network RPN can also be constructed, for example, at least partially, on a LAN (local area network) and/or designed as a data network.

A combination facility could be formed from a charge facility according to the invention and a network node according to the invention, for example, the charge server ACC1 could be integrated into the switching centre PB22 as, for example, a program module or plug-in card. Furthermore, the charge server ACC2 could be integrated into the switching centres SW1 or SW2.

The functions of a private switching centre according to the invention, e.g. those of the switching centre PB22, could be performed by a public switching centre acting externally as a private switching centre, also known by the term “CENTREX”, which is modified according to the invention.

It is also possible for distributed local private branch networks to be linked to a common, e.g. company-wide private branch network or so-called “private network”, the terminals of which can be accessed, as far as possible, via a company-wide call number plan. Such a company-side private branch network can be created by interconnecting different private branch exchanges, e.g. by interconnecting the switching centres PB11, PB21, PB22 which communicate with one another via tie lines by means of so-called tie line protocols, e.g. the IPNS protocol (ISDN PABX Networking Specification), the QSIG protocol, the ABC protocol of the Alcatel company or the CorNet protocol of the Siemens company. In this case, for example, the switching centre PB11 is installed at a first company location and PB21, PB22 at a second company location. As in the case of a VPN, a private call number plan can also be set up in such a private network for the connected subscribers, in the example, the subscribers S211, S212, S213, S221, S222; S111, S112, S113 and managed and used through the switching centres PB11, PB21, PB22. For example, the charge server ACC1 then serves the private network as a charge facility for recording private and/or business connection costs incurred for the subscribers S211, S212, S213, S221, S222; S111, S112, S113 and operates, for example, in the manner described above for the telecommunication network RPN. The charge server ACC1 communicates with the switching centres PB11, PB21, PB22 by means of, for example, one of the said tie line protocols or other, e.g. proprietary, protocol.

It is also possible for the charge server ACC2 to be a so-called customer care and billing centre (CCBC) and, in addition to the recording according to the invention, to record, in the usual and known manner, usage charges for the use of the telecommunication network PSTN on accounts which are managed through the charge server ACC2 for subscribers connected to the telecommunication network PSTN.

It is understood that any combinations of the measures and arrangements stated in the claims and in the description are possible.

1. Method for charging individual connection costs for a subscriber terminal connected to a private telecommunication network, in which
a private account is set up for the subscriber in a charge facility of the private telecommunication network,
both a connection request for the establishment of a connection and a debit code by which it is specified that the connection costs incurred for the connection are to be allocated to the private account are sent to the private telecommunication network from the terminal,
the charge facility allocates to the private account the connection costs for the requested connection, and
the connection requested by the subscriber is only established if, and/or only maintained for as long as the private account is in credit.

2. Method according to claim 1, wherein the private telecommunication network rejects connections requests of the subscriber to predefined destinations on the basis of predefined restriction criteria and the private telecommunication network does not apply the restriction criteria to the connection request to be charged to the private account or applies them only to a limited extent.

3. Method according to claim 2, wherein the restriction criteria prohibit in principle the establishment of the connection via at least one predefined transmission path and the private telecommunication network permits the establishment of the connection of which the connection costs are allocated to the private account via the at least one predefined transmission path.

4. Method according to claim 1, wherein the private telecommunication network preferably establishes the connection on a transmission path predefined by the subscriber.

5. Method according to claim 1, wherein the charge facility sends to the terminal a message concerning the respective status of the private account so that the terminal can visually and/or acoustically indicate the status to the subscriber.

6. Method according to claim 1, wherein the terminal sends to the private telecommunication network, as a debit code or in conjunction with the latter, a personal code and/or a password assigned to the subscriber.

7. Method according to claim 1, wherein the private account is anonymized, the subscriber identifying and/or authenticating himself to the charge facility for a credit operation to the private account and/or a debit operation from the private account.

8. Method according to claim 1, wherein charges which are incurred for connections requested by the subscriber and allocated to his private account are determined according to a charge tariff which is individually applicable to the private telecommunication network.

9. Method according to claim 9, wherein the connection is preferably established on transmission paths of the private telecommunication network, in particular, on transmission paths between switching centres of the private telecommunication network.

10. Method according to claim 9, wherein charges incurred for connection sections established outside the private telecommunication network are charged to the private account.

11. Method according to claim 1, wherein the private telecommunication network is a virtual private telecommunication network and/or the private telecommunication network comprises at least one private switching centre.

12. Method according to claim 1, wherein the private account is stored as a constituent part of a subscriber profile of the subscriber which comprises, in particular, a personal abbreviated dialling directory and/or a personal telephone book and/or a least-cost routing table of the subscriber.

13. Nodal point program module for a network node of a private telecommunication network, in particular, for a switching centre or a gateway, for charging individual connection costs for a subscriber terminal connected to the private telecommunication network which
contains program code which can be executed by a control means of the network node,
comprises connection means for receiving a connection request of the terminal for the establishment of a connection and for receiving a debit code by which it is specified that the connection costs incurred for the connection are to be allocated to a private account of the subscriber, the connection means being designed for establishing the requested connection,
comprises charge recording means for allocating to the private account connection costs incurred for the requested connection, and
the charge recording means and the connection means are adapted to operate together in such a way that the connection requested by the subscriber is only established if, and/or only maintained for as long as the private account is in credit.

14. Nodal point program module according to claim 13, wherein the charge recording means are designed as an internal charge facility managing the private account and/or the connection means are designed for connecting an external charge facility managing the private account and the charge collection means are designed for interactively charging the incurred connection costs in combined operation with the external charge facility.

15. Network node of a private telecommunication network, in particular, a switching centre or gateway, for charging individual connection costs for a subscriber terminal connected to the private telecommunication network which
comprises connection means for receiving a connection request of the terminal for the establishment of a connection and for receiving a debit code by which it is specified that the connection costs incurred for the connection are to be allocated to a private account of the subscriber, the connection means being designed for establishing the requested connection,
comprises charge recording means for allocating to the private account connection costs incurred for the requested connection, and
the charge recording means and the connection means are adapted to operate together in such a way that the connection requested by the subscriber is only established if, and/or only maintained for as long as the private account is in credit.

16. Charge program module for a charge facility for charging individual connection costs for a subscriber terminal connected to a private telecommunication network which contains program code which can be executed by a control means of the charge facility and/or by a control means of a network node of the private telecommunication network, wherein the charge program module comprises account management means for managing a private account of the subscriber, the account management means are designed for recording of a credit, the account management means are designed for debiting of connection costs which are incurred for a connection which requested from the terminal together with a debit code for the private account and which is established by the private telecommunication network, and the account management means are adapted for operating together with the private telecommunication network, in particular, with a network node of the private telecommunication network, in such a way that the connection requested by the subscriber is only established if, and/or only maintained for as long as the private account is in credit.

17. Charge facility for charging individual connection costs for a subscriber terminal connected to a private telecommunication network, wherein the charge facility comprises account management means for managing a private account of the subscriber, the account management means are designed for recording a credit, the account management means are designed for debiting connection costs which are incurred for a connection which requested from the terminal together with a debit code for the private account and which is established by the private telecommunication network, and the account management means are adapted for operating together with the private telecommunication network, in particular, with a network node of the private telecommunication network, in such a way that the connection requested by the subscriber is only established if, and/or only maintained for as long as the private account is in credit.

18. Storage means, in particular, diskette, CD-ROM, digital versatile disc, hard disk drive or the like, with a nodal point program module according to claim 13 stored on it and/or a charge program module according to claim 16 stored on it.
